(19) United States
(12) Patent Application Publication
(10) Pub. No.: US 2013/0160720 A1
(43) Pub. Date: Jun. 27, 2013

(54) LAMB AND GOAT SWEAT JACKET

(71) Applicants: Anthony Corcoran, New Waverly, TX (US); Sonja Corcoran, New Waverly, TX (US)

(72) Inventors: Anthony Corcoran, New Waverly, TX (US); Sonja Corcoran, New Waverly, TX (US)

(21) Appl. No.: 13/337,026

(22) Filed: Dec. 23, 2011

(51) Int. Cl. A01K 13/00; A01K 29/00

(52) U.S. Cl. 119/850; 119/174

(57) ABSTRACT

An animal covering is adapted to be placed on a portion of a show animal, such as a lamb or goat, to assist in the reduction of unwanted fat from the rib, shoulder and neck region of the animal. The animal covering may be snuggly placed on the animal with adjustable fasteners and may aid in the reduction in fat over the covered area of the animal via changes in the metabolic cell rate and/or a sweating process.

### BACKGROUND OF THE INVENTION

The present invention relates to animal conditioning methods and apparatus and, more particularly, to a lamb and goat sweat jacket that assists in the reduction of unwanted fat from the rib, shoulder and neck region of a market lamb or goat.

In maturing market show lambs and in meat show goats, the rib, shoulder and neck regions accumulate excess unwanted fat, which is hard to reduce. This unwanted fat is unappealing in the show ring for a show animal.

As can be seen, there is a need for an apparatus and method for reducing unwanted fat in show animals.

### SUMMARY OF THE INVENTION

In one aspect of the present invention, an animal cover comprises first and second torso region flaps adapted to be extended over a torso of an animal; first and second neck flaps attached to and extending diagonally from one edge of the first and second torso region flaps, the first and second neck flaps adapted to circumscribe a neck of the animal; first and second leg holes adapted to accept front legs of the animal there through; torso region fasteners adapted to connect the first and second torso region flaps together about the torso of the animal; and neck region fasteners adapted to connect the first and second neck flaps together about the neck of the animal.

In another aspect of the present invention, a animal cover for reducing fat on an animal comprises first and second torso region flaps adapted to be extended over a torso of an animal; first and second neck flaps attached to and extending diagonally from one edge of the first and second torso region flaps, the first and second neck flaps adapted to circumscribe a neck of the animal; first and second leg holes adapted to accept front legs of the animal there through; torso region fasteners adapted to connect the first and second torso region flaps together about the torso of the animal; neck region fasteners adapted to connect the first and second neck flaps together about the neck of the animal; a joint notch formed on opposite sides of the animal cover where the first and second torso region flaps connect to the first and second neck flaps; and a joint strap adapted to span across the joint notch, wherein the torso region fasteners include an elastic portion and a solid portion.

In a further aspect of the present invention, a method for reducing fat in an animal comprises positioning an animal's front legs through first and second leg holes in an animal cover; securing first and second torso region flaps of the animal cover over a torso of the animal; and securing first and second neck flaps of the animal cover about a neck of the animal, the first and second neck flaps being attached to and extending diagonally from one edge of the first and second torso region flaps.

These and other features, aspects and advantages of the present invention will become better understood with reference to the following drawings, description and claims.

### BRIEF DESCRIPTION OF THE DRAWINGS

FIG. 1 is a side view of an animal covering, in use, according to an exemplary embodiment of the present invention;

FIG. 2 is a perspective view of the animal covering of FIG. 1 in a state of initial application on an animal;

FIG. 3 is a perspective view of the animal covering of FIG. 1 in a fully applied state;

FIG. 4 is an outer view of the animal covering of FIG. 1; and

FIG. 5 is an inner view of the animal covering of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an animal covering adapted to be placed on a portion of a show animal, such as a lamb or goat, to assist in the reduction of unwanted fat from the rib, shoulder and neck region of the animal. The animal covering may be snuggly placed on the animal with adjustable fasteners and may aid in the reduction in fat over the covered area of the animal via changes in the metabolic cell rate and/or a sweating process.

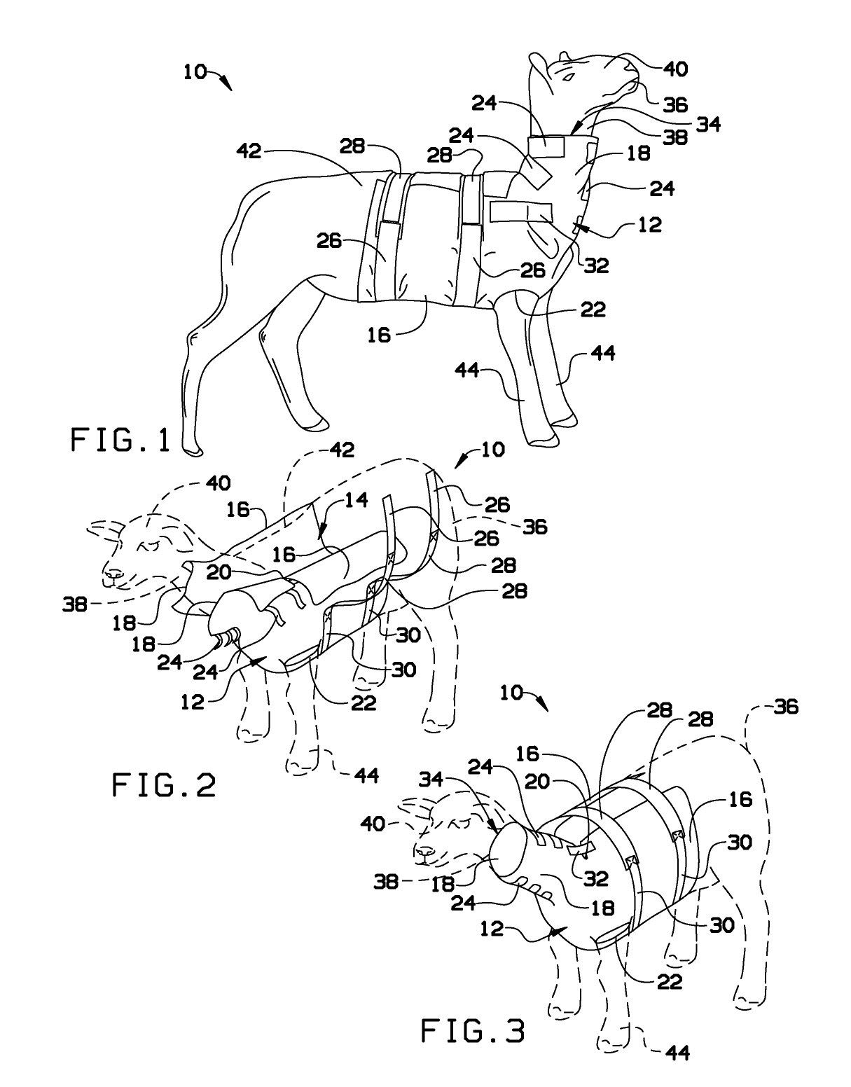

Referring now to FIGS. 1 through 5, an animal cover 10 may be designed to cover select areas of a show animal 36, such as a lamb or goat. The animal cover 10 may include an inner surface 14, adapted for contact with the animal 36, and an outer surface 12. The animal cover 10 may be made of various materials, such as, but not limited to, neoprene, vinyl, rubberized material, cotton duct, cordura denier, denim, plastic or any combination of these materials. The animal cover 10 may be made in various colors, designs and fabrics.

The animal cover 10 (also referred to as a sweat jacket) may be secured with fasteners, such as hook and loop fasteners, on portions of the animal 36 while leaving other areas of the animal 36 exposed. The animal cover 10 over the covered area may affect the metabolic cell rate and/or a sweating process, which aids in the reduction in fat over the covered area of the animal 36. In some embodiments, the animal cover may include a temperature reading gauge strip or monitoring device (not shown) for determining the temperature of the animal 36.

The animal cover 10 may include first and second torso region flaps 16 connected to first and second neck region flaps 18. The torso region flaps 16 may form a generally rectangular shape. The neck region flaps 18 may extend diagonally, in opposite directions, from one side of the torso region flaps 16, forming a V-shape between the neck region flaps 18. First and second leg holes 22 may be disposed where the torso region flaps 16 meet the neck region flaps 18 for the animal's front legs 44. Along an outer edge of the animal cover 10, where the torso region flaps 16 meet the neck region flaps 18, a joint notch 20 may be disposed to permit comfortable joint movement of the animal 36. The joint notch 20 may be covered with a joint strap 32. In some embodiments, the joint strap 32 may be an elastic member.

The fasteners may include torso region fasteners 26 for the torso region flap 16 adapted to be disposed about an animal's torso 42. In some embodiments, the torso region flap 16 may cover a rib portion of the torso 42, while leaving a back portion exposed, as shown in FIG. 3. The torso region fasteners 26 may be attached to and extend from one side of the torso region flap 16. The torso region fasteners 26 may include a solid strap portion 30 and an elastic strap portion 28. The torso region flap 16 may be snuggly applied to the torso 42 by stretching the elastic strap portion 28 and securing the torso region fastener 26 over the animal's back to an opposite side of the torso region flap. From one to four torso region fasteners 26 may be used, typically two torso region fasteners 26, for securing the torso region flap 16.

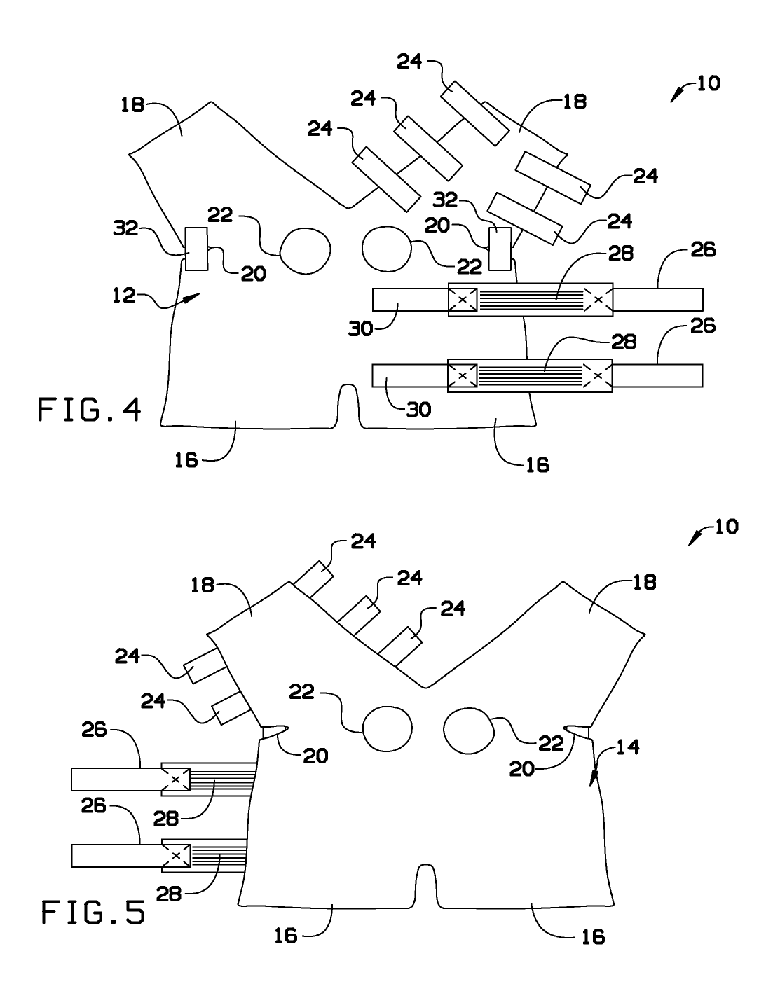

The fasteners may include neck region fasteners 24. The neck region fasteners 24 may extend from opposite sides of one of the neck region flaps 18, as shown in FIG. 4. In some embodiments, the neck region fasteners 24 may be disposed on both neck region flaps 18. The neck region fasteners 24 may secure the animal cover 10 about the animal's neck 38, leaving its head 40 uncovered. In some embodiments, the neck region flaps 18 may circumscribe the entire circumference of the animal's neck 38. The neck region fasteners 24 may include from 3 to about 7, typically about 5, neck region fasteners.

In use, the animal cover 10 may be placed on the animal 36 and secured with the fasteners 24, 26. The animal 36 may be monitored, typically daily, for the desired results and to prevent overheating or irritation. As results are achieved, the animal cover 10 may be tightened to continue to provide a snug fit about the animal 36.

It should be understood, of course, that the foregoing relates to exemplary embodiments of the invention and that modifications may be made without departing from the spirit and scope of the invention as set forth in the following claims.

What is claimed is:

1. An animal cover comprising:
first and second torso region flaps adapted to be extended over a torso of an animal;
first and second neck flaps attached to and extending diagonally from one edge of the first and second torso region flaps, the first and second neck flaps adapted to circumscribe a neck of the animal;
first and second leg holes adapted to accept front legs of the animal there through;
torso region fasteners adapted to connect the first and second torso region flaps together about the torso of the animal; and
neck region fasteners adapted to connect the first and second neck flaps together about the neck of the animal.

2. The animal cover of claim 1, wherein the torso region fasteners include an elastic portion and a solid portion.

3. The animal cover of claim 1, further comprising a joint notch formed on opposite sides of the animal cover where the first and second torso region flaps connect to the first and second neck flaps.

4. The animal cover of claim 3, further comprising a joint strap adapted to span across the joint notch.

5. The animal cover of claim 1, wherein the first and second torso region flaps span about the torso of the animal with a space therebetween at a top back portion of the animal.

6. An animal cover for reducing fat on an animal, the animal cover comprising:
first and second torso region flaps adapted to be extended over a torso of an animal;
first and second neck flaps attached to and extending diagonally from one edge of the first and second torso region flaps, the first and second neck flaps adapted to circumscribe a neck of the animal;
first and second leg holes adapted to accept front legs of the animal there through;
torso region fasteners adapted to connect the first and second torso region flaps together about the torso of the animal;
neck region fasteners adapted to connect the first and second neck flaps together about the neck of the animal;
a joint notch formed on opposite sides of the animal cover where the first and second torso region flaps connect to the first and second neck flaps; and
a joint strap adapted to span across the joint notch, wherein
the torso region fasteners include an elastic portion and a solid portion.

7. The animal cover of claim 1, wherein the first and second torso region flaps span about the torso of the animal with a space therebetween at a top back portion of the animal.

8. A method for reducing fat in an animal, comprising:
positioning an animal's front legs through first and second leg holes in an animal cover;
securing first and second torso region flaps of the animal cover over a torso of the animal; and
securing first and second neck flaps of the animal cover about a neck of the animal, the first and second neck flaps being attached to and extending diagonally from one edge of the first and second torso region flaps.

9. The method of claim 8, wherein the first and second torso region flaps are connected with torso region fasteners having a solid portion and an elastic portion.

10. The method of claim 8, further comprising monitoring the animal for irritation of the animal and for progress in reduction of fat.
